(19) United States
(12) Patent Application Publication
(10) Pub. No.: US 2002/0038426 A1
(43) Pub. Date: Mar. 28, 2002

(54) Method and a system for improving logon security in network applications

(76) Inventors: Marcus Pettersson, Lund (SE); Georg Lysen, Lund (SE)

Correspondence Address: NIXON & VANDERHYE P.C., 8th Floor, 1100 North Glebe Rd., Arlington, VA, 22201-4714, US

(21) Appl. No.: 09/727,695

(22) Filed: Dec. 4, 2000

(30) Foreign Application Priority Data
Sep. 28, 2000 (SE) 0003464-5

(51) Int. Cl. H04L 9/32

(52) U.S. Cl. 713/186

(57) ABSTRACT

A computer system is provided for authentication of an individual at a client station (1) seeking access to a server station (2). The client station (1) obtains biometric data from the individual at the client station (1) and supplies the biometric data to the server station (2). The server station compares the biometric data with data from one or more records of enrolled individuals, and if the comparison is successful the server station (2) creates a random password, which is transmitted from the server station (2) to the client station (1). The client station (1) uses the password to authenticate the individual.

### TECHNICAL FIELD

The present invention relates to a computer system and a method for improving the security when a client logs on to a server in a network, and more specifically to a system and method for improving the security when a user of a web browser logs on to a web server, wherein the user is identified and authenticated by means of a biometric attribute such as a fingerprint.

### BACKGROUND ART

A person using the Internet or the World Wide Web (WWW) will gain access to a vast variety of information and services. The information on the Internet comprises many different forms of media, e.g. text, pictures, movies and music, which are normally arranged as so-called hypertext documents. These documents are constructed in conformity with one of various accepted formats or languages, e.g. Hypertext Markup Language (HTML), which is used for describing the content and structure of the hypertext documents.

The normal way for a person to explore the Internet is by the use of a browser software program acting as an Internet client communicating with an Internet server. Internet servers are software programs that support various features, including being compatible with one or more standard protocols, e.g. the Hypertext Transport Protocol (HTTP) used for the transfer of hypertext documents from the server to the client, and the File Transport Protocol (FTP) which supports the transfer of files from one computer to another. The main function of the server is to provide specific services and documents to the browser dependent on the characteristics of the user of the browser, i.e. a person with a higher authorization will gain access to documents that are classified and inaccessible to a person with a lower authorization. A typical situation where a person may benefit from a higher authorization level is an Internet banking operation involving a personal banking account. The owner of the account is of course authorized to access the account as well as other services provided by the bank, while another person with a lower authorization will only have access to ordinary banking services, e.g. currency conversion. The low authorization mentioned above may be due to the fact that the person in question is not a customer at the bank.

In order to gain access to the services or the documents the client must satisfy the server's security requirements, i.e. the server requires some form of identification to authenticate the client before providing the requested documents. The authentication may take various forms, but the main purpose is to verify that the person at the client station seeking access to the server is in fact who that person claims to be.

The de facto standard and most straightforward method to authenticate a person seeking access to a network is to use secret passwords. This is a simple and in most cases reasonably safe way to make sure that no unauthorized person gains access to the server, but at the same time a person who is authorized to access the server will have to go through one or more authorization procedures and enter his password at least once during the procedure. To keep the security at a sufficiently high level the password has to be made up of many characters in a random fashion, and it also has to be changed frequently to make sure that no unauthorized person gets hold of the password.

This implies that the user has to remember all the passwords he uses, which may be cumbersome if the person is a frequent user of the Internet. He may also write down the passwords as an alternative to remembering them, but this will of course reduce the security level significantly.

Another approach to authenticate a person seeking access to a server is to obtain biometric characteristics from the person in question. Today, many different forms of biometric data can be obtained from dedicated biometric sensors in order to verify the identity of a person.

The patent document U.S. Pat. No. 5,930,804 discloses a method for biometric authorization, where biometric I/O devices comprise technologies that acquire selected data relating to biometric characteristics of the individual who is using the client station. Examples of biometric characteristics presented in the text are voice pattern, retinal pattern, fingerprint, and typing pattern.

Although the security is enhanced by the use of biometric verification, the logon procedure used in many network systems today is not adapted to make use of biometric sensors. This is due to the fact that up until now, the use of passwords has been the only feasible approach, since the price and complexity of biometric sensors have prevented an extensive use of them in network applications.

A typical logon procedure starts when a user of a browser at the client station enters a user name and password in a logon form at the client station. A unique identifier is sent together with a request for access, which is then used by the server to keep track of all the different clients that may be logged on at the same time. Since the browser creates the identifier when the logon form is completed, it is from obvious security reasons very difficult to emulate the identifier. To be able to utilize a biometric logon solution, the logon form has to be completed automatically when the user has proven his identity by means of biometric verification. One way to do this is to save the user password at the client station and then use a script language such as JavaScript to automatically fill in the logon form upon request. However, this method does not enhance the security compared to a conventional password system, due to the fact that the actual user password is stored at the client station and is thereby obtainable for a fraudulent unauthorized person using the client station.

### SUMMARY OF THE INVENTION

An object of the present invention is to provide a method and a system for enhancing the security when a person logs on to a server station adapted to utilize a password logon procedure.

This is accomplished by using biometric data, obtained from the person seeking access to the server, to authenticate the person as an authorized user. The biometric data can be extracted from any unique biometric feature, such as a voice pattern, retinal pattern, fingerprint, etc.

If the person seeking access to the server is an enrolled authorized user, a random password is dynamically generated at the server station and transferred via an encrypted communication channel to the client station, where the browser software uses the received password to fill in the logon form. Generally, the dynamically generated password is deleted at the server station when the logon procedure is completed, but as a further security enhancement the password is always deleted, when a specific period of time has elapsed since the password was first created.

These and other objects, features and advantages of this invention will become abundantly clear to the reader in the following detailed disclosure of the present invention, from the appended claims as well as from the accompanying drawings.

### BRIEF DESCRIPTION OF THE DRAWINGS

A preferred embodiment of the present invention will now be described in more detail, reference being made to the accompanying drawings, in which:

FIG. 1 is a schematic drawing of a preferred embodiment of a client-server solution utilizing a biometric logon method according to the present invention,

FIG. 2 is a flow chart illustrating an embodiment of the method according to the invention for a client station to logon to a server station, and

FIGS. 3-5 are schematic drawings of the logon form in greater detail.

### DETAILED DISCLOSURE OF A PREFERRED EMBODIMENT

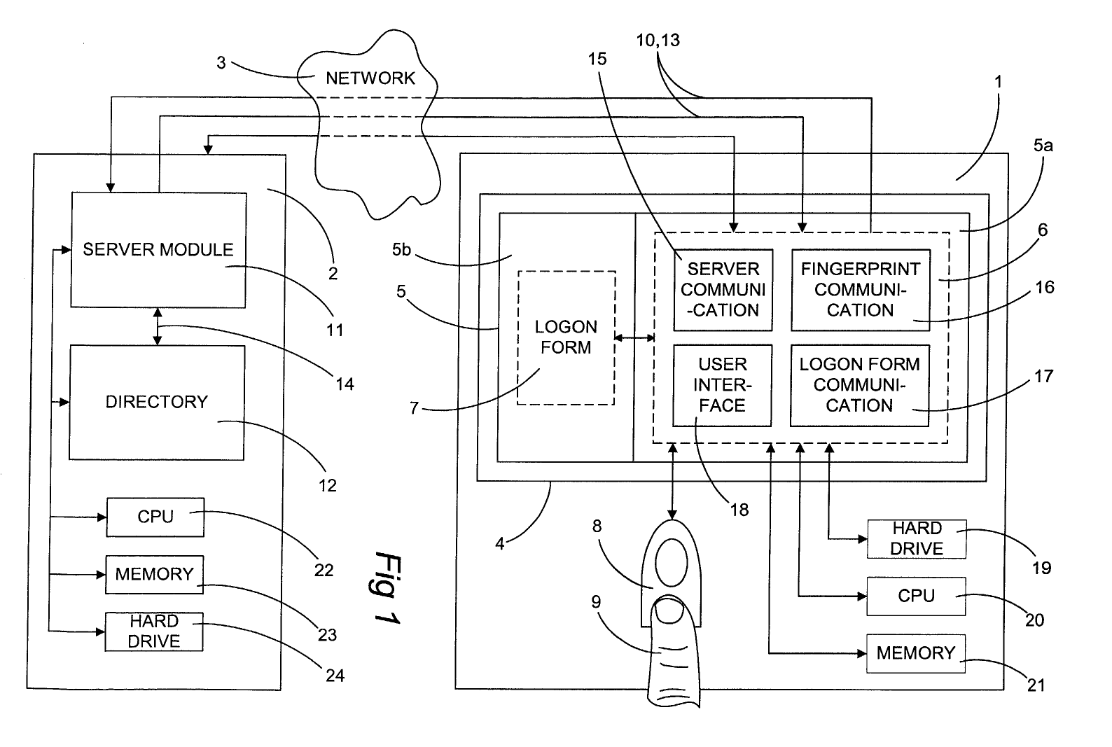

FIG. 1 illustrates a client station 1, which has operative access to a server station 2 through a computer network 3, such as the Internet. Both the client station 1 and the server station 2 may be implemented by any available computer equipment. The client 1 comprises a browser software 4, which in a preferred embodiment supports the Hypertext Markup Language at least as it is specified in version 4.0 (HTML 4.0). This implies that among other features, such as the capability to manage Web pages (i.e. a presentation of a hypertext document so that it can be distributed in different languages), the browser also supports frames 5. Generally this means that a Web page may comprise two or more frames 5, each frame being built as a separate HTML file which can interact with the other frames in a number of ways. For instance, a link in one frame can request a file at a remote location, that will appear in another frame. A typical use of frames is to have one frame which contains a controller, e.g. a selection menu, and another frame that contains the space where the result of the action in the first frame is presented.

A Component Object Model (COM) object 6, according to a specification from Microsoft Corp., One Microsoft Way, Redmond, Wash. 98052-6399 USA describing objects and interfaces in a language and location independent manner, is loaded in a first frame 5a on the Web page, while another frame 5b contains a logon form 7 that is to be sent to the server 2 as a request for access. As a first action in a logon procedure according to the invention, the COM object verifies that a fingerprint reader 8, such as a Precise 100 SC from Precise Biometrics, Dag Hammarskjölds v 2, SE-224 64, Lund, Sweden, is installed on the client station 1.

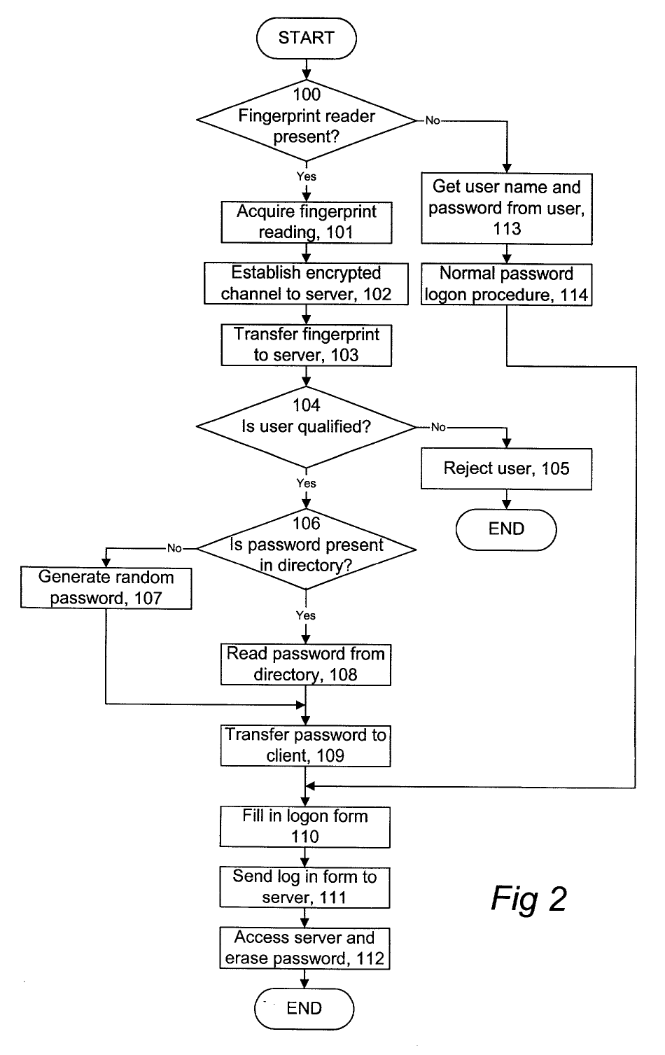

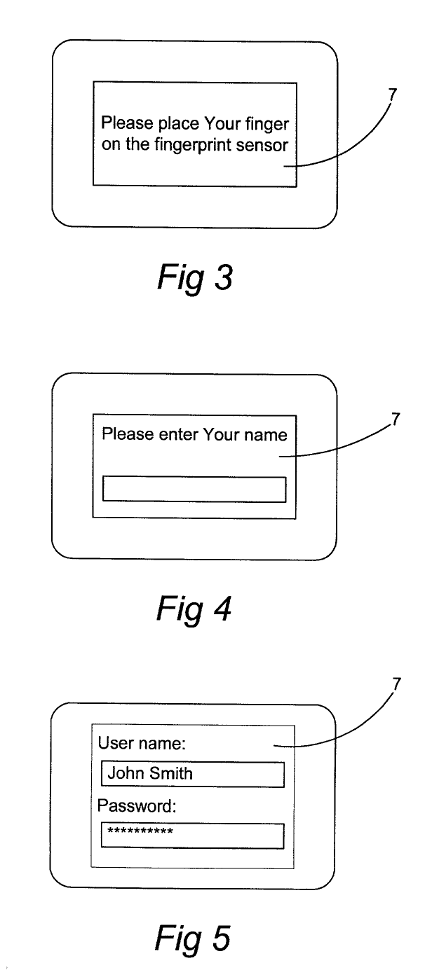

If the COM object 6 detects an installed fingerprint reader 8, as indicated by a block 100 in FIG. 2, the user is requested to place his finger 9 on the reader for obtaining a picture of the actual fingerprint, as is shown in FIG. 3 and in block 101 in FIG. 2. This picture can be in the form of a bitmap picture or a mathematically processed picture.

As an alternative to a picture of the fingerprint, the COM object 6 can receive a certificate from the fingerprint reader 8 identifying and certifying the user without departing from the principles of the invention. In such a case the fingerprint reader itself will contain information related to the different users of the client station 1, and the manufacturer of the fingerprint reader will be certified by a trusted certification company, such as VeriSign, 1350 Charleston Road, Mountain View, Calif. 94043 USA or Digital Signature Trust Co., 1095 East 2100 South, Suite #201, Salt Lake City, Utah 84106 USA.

If no fingerprint reader 8 is detected by the COM object 6 in block 100, a conventional logon procedure will take place as shown in FIG. 5, and blocks 113 and 114 in FIG. 2.

As shown in blocks 102 and 103 in FIG. 2, the COM object 6 then establishes an encrypted communication channel 10 to a server module 11 in the server station 2. The picture of the fingerprint is transferred to the server module 11 and, optionally, the user name of the actual user is also transferred to the server module 11.

In blocks 104-109 in FIG. 2 the server module 11 first checks, in block 104, if the user seeking access to the server station 2 is an enrolled authorized user. In the case of an authorized user seeking access to the server station 2, the server module 11 then checks, in block 106, if the user already has a password in a server directory 12. If no password is registered in the server directory 12, the server generates a 128 character long random password in block 107 and saves it in the server directory 12. The password, pre existing or randomly generated, is then transferred in block 109 via the encrypted channel 10 to the COM object 6 on the client station 1. Otherwise the server module 11 rejects the user in block 105 and the logon procedure terminates.

As shown in block 110 in FIG. 2, the COM object 6 uses the password sent from the server module 11 to fill in the appropriate field in the logon form 7 in the frame 5b on the client station 1. The user name may either be sent from the server module 11 together with the password or it may be retrieved directly from the user of the client station 1, as shown in FIG. 4. In certain cases the COM object will not be able to fill in the logon form 7, as it can be classified as a forbidden action. In these cases the COM object may indicate that the logon procedure will continue after the user has pressed a “Logon” button. This action will trigger a script preferably written in JavaScript code, which fetches the user name and password from the COM object and fills in the logon form.

The COM object sends the logon form 7 to the server station 2, whereby the client 1 gets logged on to the server, indicated by blocks 111 and 112 in FIG. 2. To make sure that no unauthorized person gets hold of the randomly generated password, it is erased from the server directory 12 after a maximum period of three minutes, as disclosed by block 112 in FIG. 2.

The main task for the server module 11, residing in a computer memory 23 or on a hard drive 24 at the server station 2, is to communicate in two directions when it is executed on the server station by a CPU 22. In the first direction 13 the communication is directed towards the COM object 6 and is preceded by a listening procedure, where the server module 11 awaits a request for access from a client 1. The second direction of communication 14 is pointed towards the server directory 12, which can take various forms dependent on the server implementation. In a preferred embodiment the server module 11 communicates towards the application and messaging server program Domino from Lotus Development Corporation, 55 Cambridge Parkway, Cambridge, Mass. 02142 USA, but any other server program, such as the Microsoft Exchange Server from Microsoft Corp., may be used without departing from the principles of the invention. The server module is preferably written in a high level language such as C++, but any other available programming language such as the platform independent Java language may be used.

The COM object 6 comprises four parts according to a preferred embodiment, residing in a computer memory 21 or on a hard drive 19 and being executable by a CPU 20 at the client station: communication routines 15 for establishing contact with the server module 11 and for transferring data to and forth the server module 11, software drivers 16 for communication with the fingerprint reader 8, communication routines 17 for transfer of data to and forth the logon form 7, and a user interface 18 to interact with the user at the client station 1. To be able to perform the communication with the logon form 7 and possible JavaScripts, the client station 1 has to comprise a COM object 6. In a preferred embodiment the COM object 6 is implemented using a platform independent language such as Java. This makes it possible to use the COM object 6 together with different browsers, e.g. Netscape Navigator from Netscape Communications Corp., 501 E. Middlefield Road, Mountain View, Calif. 94043 USA or Internet Explorer from Microsoft Corp., but the COM object 6 could also be implemented using a platform dependent language such as C++ or VB with the restriction that the COM object 6 will then function only with one platform.

The invention has been described above with reference to a preferred embodiment. However, the present invention shall in no way be limited by the description above; the scope of the invention is best defined by the appended independent claims. Other embodiments than the particular one described above are equally possible within the scope of the invention.

1. An authentication method to authenticate an individual at a client station (1) seeking access to a server station (2), comprising the steps of obtaining (101) biometric data from the individual at the client station, supplying (103) the data to the server station, and comparing (104) the data received in the server station with data from one or more records of enrolled individuals, characterized by the steps of:
creating (107) or reading (108) a random password at the server station (2) when an authorized individual seeks access,
transmitting (109) the password from the server station to the client station (1), and
using (110) the password at the client station to authenticate the individual.

2. A method according to claim 1, wherein the random password is deleted (112) when a specified period of time has elapsed since the password was created.

3. A method according to claim 1 or 2, wherein the biometric data includes fingerprint data provided by a fingerprint reader (8).

4. A method according to any of claims 1-3, wherein the fingerprint reader (8) provides a digital certificate ensuring the identity of the individual at the client station (1).

5. A method according to any preceding claim, wherein an encrypted communication channel (10) is established (107) between the server station (2) and the client station (1) prior to supplying (103) the biometric data to the server station.

6. A method according to claim 5, wherein the encrypted communication channel (10) is established over the Internet.

7. A method according to any preceding claim, comprising the further steps of:
inserting (110) the password in a logon form (7) at the client station (1),
transmitting (111) the logon form to the server station (2), and
completing the authentication of the individual upon reception of the logon form in the server station.

8. A computer system for authentication of an individual seeking access to a server station (2) from a client station (1), where the client station (1) is adapted to obtain biometric data from the individual and to supply the biometric data to the server station (2), said server station being adapted to compare the biometric data with data from one or more records of enrolled individuals, characterized in that
the server station (2) is adapted to create a random password when an authorized individual seeks access to the server station, and to transmit the password from the server station to the client station (1), and in that
the client station (1) is adapted to use the password to authenticate the individual.

9. A computer system according to claim 8, wherein the client station (1) comprises a COM object (6)

10. A computer system according to claim 8 or 9, wherein the server station is adapted to delete the random password when a specified period of time has elapsed since the password was created.

11. A computer system according to any of claims 8-10, wherein the biometric data includes fingerprint data provided by a fingerprint reader (8), coupled to the client station (1).

12. A computer system according to any of claims 8-11, wherein the fingerprint reader (8) is adapted to provide a digital certificate ensuring the identity of the user at the client station (1).

13. A computer system according to any of claims 8-12, wherein means are provided to establish an encrypted communication channel (10) between the server station (2) and the client station (1) to be used when supplying the biometric data to the server station (2).

14. A computer system according to claim 13, wherein the encrypted communication channel (10) is established over the Internet.

15. A computer system according to any of claims 8-14, wherein the client station is adapted to insert (110) the password in a logon form (7) at the client station (1), and to transmit (111) the logon form to the server station (2), and in that
the server station is adapted to complete the authentication of the individual upon reception of the logon form in the server station.

16. A computer program product (6) directly loadable into the internal memory (21) of an electronic apparatus with digital computer capabilities (20), characterized in that the computer program product (6) comprises software code portions for performing the steps of any of the claims 1 to 6 when said product is run on said apparatus (1).
